(19) United States
(12) Patent Application Publication
(10) Pub. No.: US 2007/0174031 A1
(43) Pub. Date: Jul. 26, 2007

(54) Method and device for taking an access control policy decision

(76) Inventors: Roman Levenshteyn, Aachen (DE); Silke Holtmanns, Klaukkala (FI)

Correspondence Address: ERICSSON INC., 6300 LEGACY DRIVE, M/S EVR 1-C-11, PLANO, TX, 75024, US

(21) Appl. No.: 10/596,769

(22) PCT Filed: Dec. 23, 2003
(86) PCT No.: PCT/EP03/14799

§ 371 Date: Jun. 23, 2006

(51) Int. Cl. G06F 17/50; G06G 7/62

(52) U.S. Cl. 703/13

(57) ABSTRACT

A method and a device for taking a policy decision are disclosed. The policy decision device (S3) has access to objects being relatable to each other by relations of one or more relation types. The method comprises the steps of receiving (100) a request for the policy decision, the request specifying a first object of the objects and request information, obtaining (105) a policy matching to the request information and being applicable to a second object of the objects, obtaining (110) at least one propagation rule associated to the policy, the at least one propagation rule specifying at least one relation type of the one or more relation types, verifying if a relation path exits, the relation path linking the first object and the second object and consisting of one or more or the relations, verifying if the one or more relations of the relation path are in accordance with at least one of the at least one specified relation type, and if said the relation path are in accordance, applying the policy to the first object for taking (120) the policy decision.

### FIELD OF THE INVENTION

The present invention relates to the area of security, especially to a method and a device for taking a policy decision.

### BACKGROUND OF THE INVENTION

A company or any other kind of organization or system is typically faced with the situation to control a number of employees, computing or fabrication resources, products, customers etc. Policies are used that specify one or more rules for the control, e.g. which employees have which rights, who should have access to which resource, which security requirements have to be fulfilled for which product, which customers have to be prioritized etc.

Policies can be implemented in computing systems to automatically take a policy decision for an object. An object is an entity that is controllable by one or more policies and policies specify inter alia the rules for controlling one or more objects, e.g. specify the “who, what, when, why, where, and how” of access to objects by entities like persons or computing devices or applications. Examples for objects are person-related data of employees or other humans, data related to fabrication resources, data related to computing devices or applications operating on computing devices, network components, file systems, databases, documents etc.

In a typical situation, a requester wants to perform an action on an object which triggers a policy enforcement device, sometimes also called Policy Enforcement Point (PEP), which protects the access to said object like e.g. a file system or a web server. The policy enforcement device creates a request based on the requester's attributes, the object in question, the action, and further information like a purpose pertaining to the request. The request is sent to a policy decision device, sometimes also called Policy Decision Point (PDP), which analyzes the request for finding an appropriate policy that matches the requester's attributes, the object, the action, and possibly the further information. If a matching policy is found, the policy can be applied for taking a policy decision for the object. The policy decision is returned to the policy enforcement device, which subsequently, depending on the policy decision, allows or denies the requestor to perform the wanted action on the object.

Typically, a policy decision device has stored a set of policies for many different objects from which a policy matching to an object and to further request contents like an action is retrieved. A policy matching to an object can be found based on a unique relation between the policy and the object, i.e. the relation between the object and the policy is explicitly defined and specified, which is realized by explicitly stating all objects to which the policy applies within the policy. This approach has drawbacks for dynamic systems. In case of changes of objects, e.g. when one or more objects are newly created, disappear, or are simply renamed, corresponding statements in the policies have to be updated to appropriately reflect the changes of the objects. However, these updatings are typically carried out manually and need a lot of effort. In any case, the updating consumes processing power e.g. for compiling the updated policy to be executable by the policy decision device and for storing the updated policy. Furthermore, if new policies are defined, all objects the new policy should apply to have to be explicitly stated within said new policy, which consumes a lot of memory especially if a policy is applicable to a larger numbers of objects.

Objects can be classified. Attributes, i.e. information common to all objects of a particular class, can be associated to a class. Classes can be hierarchically ordered and relations between individual classes can be used to express the hierarchy, e.g. to state that a first class is superior in a hierarchy than a second class. Furthermore, attributes associated to the first class can be inherited to the second class (or vice versa) and can be considered by the policy decision device for taking a policy decision. Thus, for taking a policy decision on an object belonging to a first class, the policy decision device knowing the relation between the first class and a second class can take the attributes of the second class into account for taking the policy decision on the object. Information to which classes a policy applies and the corresponding relations between those classes are explicitly stated within the policy. However, explicit statements in a policy are a drawback in dynamic systems because whenever a change of a classification and/or a relation occurs, the set of policies have to be updated to reflect the change. Accordingly, for a larger number of explicit statements, a lot of memory is consumed for storing the policies.

Thus, existing methods and policy decision devices using policies explicitly stating all objects they are applicable to or explicitly stating all classes and corresponding relations require much effort, consume much processing power and memory and are thus especially unsuited for dynamic systems.

### SUMMARY OF THE INVENTION

It is an object of the present invention to provide a method, a device, and a computer program, which overcome the aforementioned shortcomings and drawbacks and are especially suitable for an application in dynamic systems.

This object is achieved by the method as described in claim 1. Furthermore, the invention is embodied in a device according to claim 7 and a computer program according to claim 13. Advantageous embodiments are described in the further claims.

A method for taking a policy decision by a policy decision device is disclosed. The method comprises several steps that can be executed step-by-step according to the sequence of mentioning. Alternative sequences are possible and some steps can be executed in parallel.

The method makes usage of objects that are relatable by relations of one or more relation types. An object can be related to one or more further objects by one or more relations. Relations between objects can be of the same type or of different types. The objects and their relations can be stored in one or more object databases and are accessible by the policy decision device.

The policy decision device receives a request for a policy decision. The request specifies a first object for which the policy decision is to be taken. The request furthermore specifies request information based on that a policy matching to the request is identifiable. Triggered by the request, the policy decision device obtains a policy matching to the request information. This policy is immediately applicable to a second object of the objects. The immediate applicability can be recognized by the policy decision device by an explicit statement of the second object in the policy or by an appropriate reference identifier for relating the policy and the second object.

If the first object and the second object are identical, the policy can be applied to the first object for taking the policy decision. However, the more common case is that the first and the second object are different objects and the policy cannot be immediately applied to the first object. For the common case, the method proceeds by obtaining at least one propagation rule associated to the policy.

A propagation rule specifies at least one relation type of a relation between objects. One or more propagation rules can be associated to a policy and each propagation rule can specify one or more relation types.

When applying a propagation rule, it can be verified if at least one relation path between said objects exists that is in accordance with at least one of specified relation type. A relation path is a continuous, non-interrupted sequence of one or more relations of one or more relation types between two or more objects.

The method further comprises the step of verifying if a relation path linking the first object and the second objects exits. The relation path can comprise zero or more related objects between the first and the second object. Furthermore, it is verified if the one or more relations of the relation path are in accordance with at least one of the at least one specified relation type.

If it is determined that the first object and the second object are related by a relation path and that the one or more relations of the relation path are in accordance with at least one of the relation types specified in the at least one propagation rule, the policy matching to the request information and being applicable to the second object is applied to the first object for taking the policy decision. Finally, the policy decision can be communicated to the policy enforcement device that requested the policy decision.

The invention is based on a propagation of a policy matching to a second object along a relation path linking the first and the second object for taking a policy decision for the first object. Accordingly, policies do no longer have to explicitly state all objects they are immediately applicable to nor do they have to state explicitly relations between objects or object classes. Thus, beside information like information indicating its matching to request information and further policy components like rules or conditions for taking the policy decision, a policy according to the invention can be associated with information indicating at minimum one object the policy is immediately applicable to and at minimum one propagation rule thus making polices very compact. According to the invention, the number of policies can be drastically reduced due to the fact that not for each and every object a policy has to be specified. Compact and fewer policies, however, reduces significantly the processing effort for the creation and compiling of a new policy, reduces memory consumption and eases the maintenance and handling. Furthermore, invention leads to an effective decoupling of the objects with their relations on the one side and the policies on the other side. Objects and relations between objects can change without the need to update policies, because a policy decision for an object in question can be taken as long as a policy is obtainable that matches to the request and is applicable to any object being linked to the object in question by a relation path in accordance with the specifications of a propagation rule associated to the policy. Due to the effective decoupling, the objects with their individual relations and the policies can be managed and maintained much more independently thus increasing the flexibility in a policy system. Changes of objects and/or relations thus do much less affect the policies and vice versa and less processing power is needed as much fewer updates of policies are needed, e.g. in case the only object a policy is immediately applicable to is renamed or discarded. Thus, the invention is especially advantageous for policy decision systems which are dynamic.

According to a preferred embodiment, the at least one propagation rule furthermore specifies at least one direction of a relation between two objects. Accordingly, it can be verified if the one or more relations of the relation path are in accordance with the at least one specified direction, i.e. the propagation rule can regulate that all relations of the relation path linking the first and the second object are directed according to the specified direction. If the one or more relations of the relation paths are not in accordance with the at least one specified direction, no policy decision is taken. Else, if the one or more relations of the relation paths are verified to be in accordance with at least one of the one or more specified relation types and the at least one specified direction, the policy decision can be taken. For example, a propagation rule may specify that all relations of a relation path have to be unidirectional, i.e. pointing from the first object along the relation path to the second object or vice versa, which can be of advantage for a policy decision for which it may be insufficient from a security point of view to base the policy decision just on the existence of a relation path in accordance with the specified one or more relation types without further checking the direction of the individual relation expressing e.g. a certain ordering or hierarchy of the objects.

According to another preferred embodiment, the at least one propagation rule specifies further at least one condition that can be verified for at least one of the first object, the second object and possible further objects of the relation path. Thus, the verification corresponding to the propagation rule can be extended from a verification of an existence of at least one relation path with relations in accordance with one or more specified relation types and possibly specified one or more directions by a further verification of one or more conditions to be fulfilled by one or more of the objects of the propagation paths providing more control over the relation path while keeping the level of decoupling between the related objects and the polices.

According to another preferred embodiment, an existence of the relation path is considered for the obtaining of the policy. Considering one or more relation paths from the first object already in the process for obtaining a policy matching to the request information can significantly enhance the probability that a propagation of the policy can be successfully performed, because the second object and the first object are already known to be linked by a relation path because of the prior consideration.

According to another preferred embodiment, the at least one propagation rule can be obtained from at least one propagation rule database on the base of at least one reference identifier associated to the at least one propagation rule and the policy. Accordingly, referencing can be used for further policy components like rules or conditions wherein at least one further policy component of the policy is obtained from at least one policy component database based on at least one reference identifier associated to the at least one further policy component and the policy. For taking a policy decision based on a policy, the corresponding referenced policy items like a referenced propagation rule and/or further referenced policy components like rules or conditions can be retrieved from the respective database. Referencing based on reference identifiers is of advantage as it overcomes the requirement to explicitly spell out propagation rules and/or further policy components within a policy. For referencing, the policy can be associated with appropriate reference identifiers pointing to the corresponding referenced items. Reference identifiers can be rather short compared to often complex rules or conditions thus shortening the policies and thus further reducing memory requirements for the storage of the policies. Referencing is especially of advantage if the same referenced item is used by multiple policies thus reducing significantly the amount of memory for the set of policies and processing effort in case of policy creation and updating. Thus, management of a larger set of policies with (at least partly) shared policy items profits to a large extent from the modularity introduced by referencing.

The invention is furthermore embodied in a policy decision device, which is described in the following.

The policy decision device for taking a policy decision comprises a receiving unit for receiving messages, a processing unit for processing of messages and information, and typically also a transmission unit for transmission of messages. The processing unit is adapted to access objects being relatable to each other by relations of one or more relation types. The receiving unit is adapted to receive a request for the policy decision, typically from a policy enforcement device. The request specifies a first object of the objects and request information. The processing unit is further adapted to obtain a policy matching to the request information and being applicable to a second object of the objects. Furthermore, the processing unit is adapted to obtain at least one propagation rule associated to the policy. The at least one propagation rule specifies at least one relation type of the one or more relation types. The processing unit is also adapted to verify if a relation path linking the first object and the second object and consisting of one or more of the relations exists. Furthermore, the processing unit is adapted to verify if the one or more relations of the relation path are in accordance with at least one of the at least one specified relation type. If said relation path exists and if said one or more relations of the relation path are in accordance with at least one of the at least one specified relation type, the processing unit is adapted to apply the policy to the first object for taking the policy decision. The processing unit can be further adapted to generate a policy decision message to be communicated via the transmission unit to the entity that requests the policy decision and/or to another entity, e.g. for information about the policy decision. The policy decision device can be used in any of the embodiments of the method as described.

The present invention also concerns a computer program comprising software code in order to implement the method as described above when operated by a processing unit of a policy decision device. The computer program can be stored on a computer readable medium. The computer-readable medium can be a permanent or rewritable memory within the policy decision device or located externally. The computer program can be also transferred to the policy decision device for example via a cable or a wireless link as a sequence of signals.

Correspondingly, the computer program loadable into the processing unit of a policy decision device comprises code adapted to access objects being relatable to each other by relations of one or more relation types, to process a request for a policy decision, the request specifying a first object of the objects and request information, to obtain a policy matching to the request information and being applicable to a second object of the objects, to obtain at least one propagation rule associated to the policy, the at least one propagation rule specifying at least one relation type of the one or more relation types, to verify if a relation path exits, the relation path linking the first object and the second object and consisting of one or more of the relations, to verify if the one or more relations of the relation path are in accordance with at least one of the at least one specified relation type, and if said relation path exists and if said one or more relations of the relation path are in accordance, to apply the policy to the first object for taking the policy decision. The computer program can comprise further code to perform or to initiate a communication of the policy decision to an entity that requests the policy decision and/or to another entity, e.g. for information about the policy decision. The computer program loadable into the processing unit of the policy decision device can be used in any of the embodiments of the method as described.

In the following, detailed embodiments of the present invention shall be described in order to give the skilled person a full and complete understanding. However, these embodiments are illustrative and not intended to be limiting, as the scope of the invention is defined by the appended claims.

### BRIEF DESCRIPTION OF THE FIGURES

FIG. 1 shows in the upper part a policy system and in the lower part a flowchart according to a first embodiment of the invention;

FIG. 2 shows a policy decision device;

FIG. 3 shows an embodiment of a policy database, a propagation rule database, and a policy component database;

FIG. 4 shows a first set of objects related by relations of different relation types;

FIG. 5 shows a second set of objects related by relations of different relation types and direction;

FIG. 6 shows a flowchart according to a second embodiment of the invention;

FIG. 7 shows a flowchart according to a third embodiment of the invention.

### DETAILED DESCRIPTION OF THE INVENTION

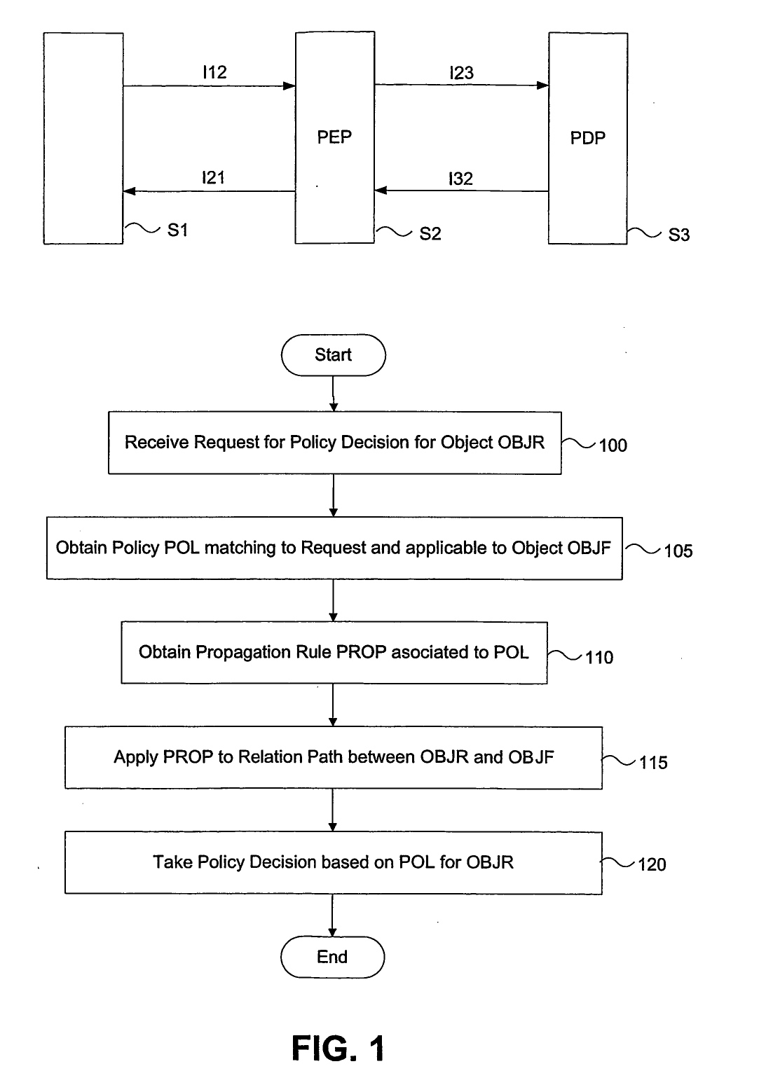

FIG. 1 shows a policy system and a flowchart revealing process steps executable by the policy decision device S3. The policy system comprises a requesting entity S1 that requests to perform an action on an object OBJR. The request is submitted from the requesting device S1 to a corresponding policy enforcement device S2 via interface I12. Before granting or denying the requesting entity S1 to perform the action on the object OBJR, the policy enforcement device S2 sends a request for taking a policy decision via interface I23 to the corresponding policy decision device S3. The request comprises at least an indication of the object OBJR for which the policy decision is to be taken and request information like information about the requested ACTION to be performed, information about the ACTOR, i.e. the requesting entity S1 and/or a user of S1, TIME information, ENVIRONMENTAL information, LOCATION information etc.

Policies can be associated with appropriate information for indicating its matching to request information of a request, e.g. a policy can explicitly state within the policy that it is corresponds to certain request information or a policy may be stored in a certain database or directory reserved for policies matching to certain request information. For example, the policies can be associated with information or stored in databases or folders indicating a matching to a certain ACTION and/or for a certain ACTOR and/or for a certain TIME and/or for a certain ENVIRONMENT and/or for a certain LOCATION etc.

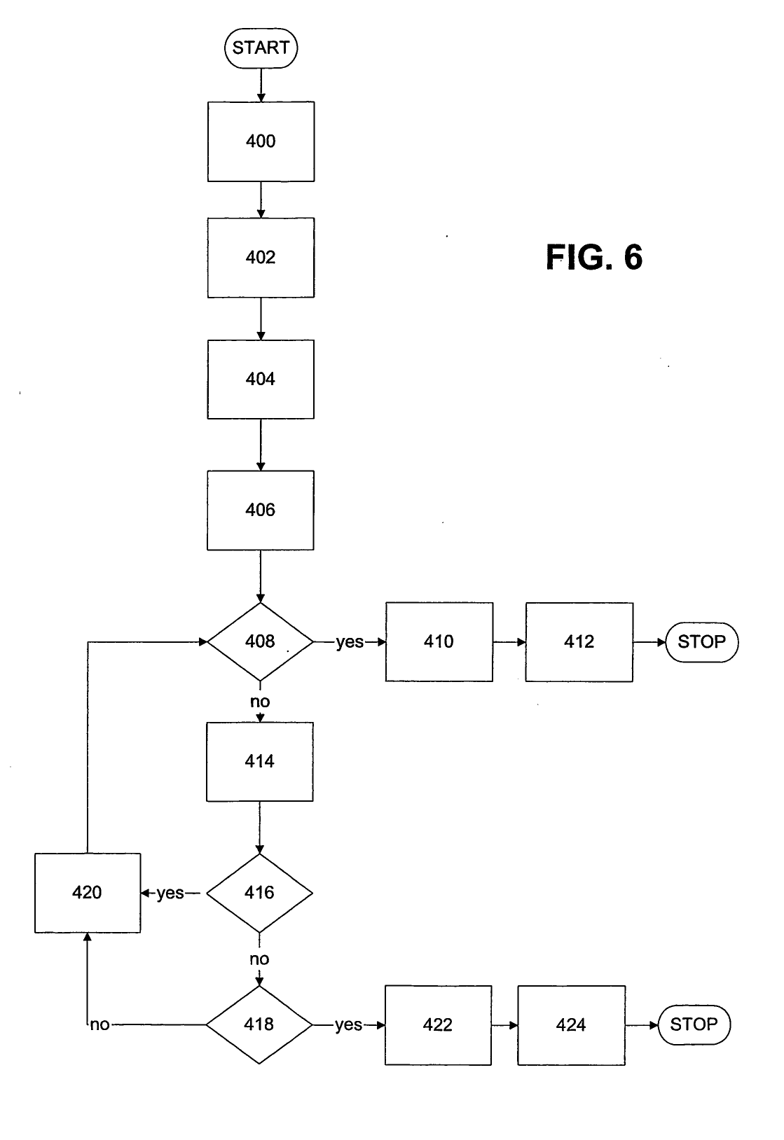

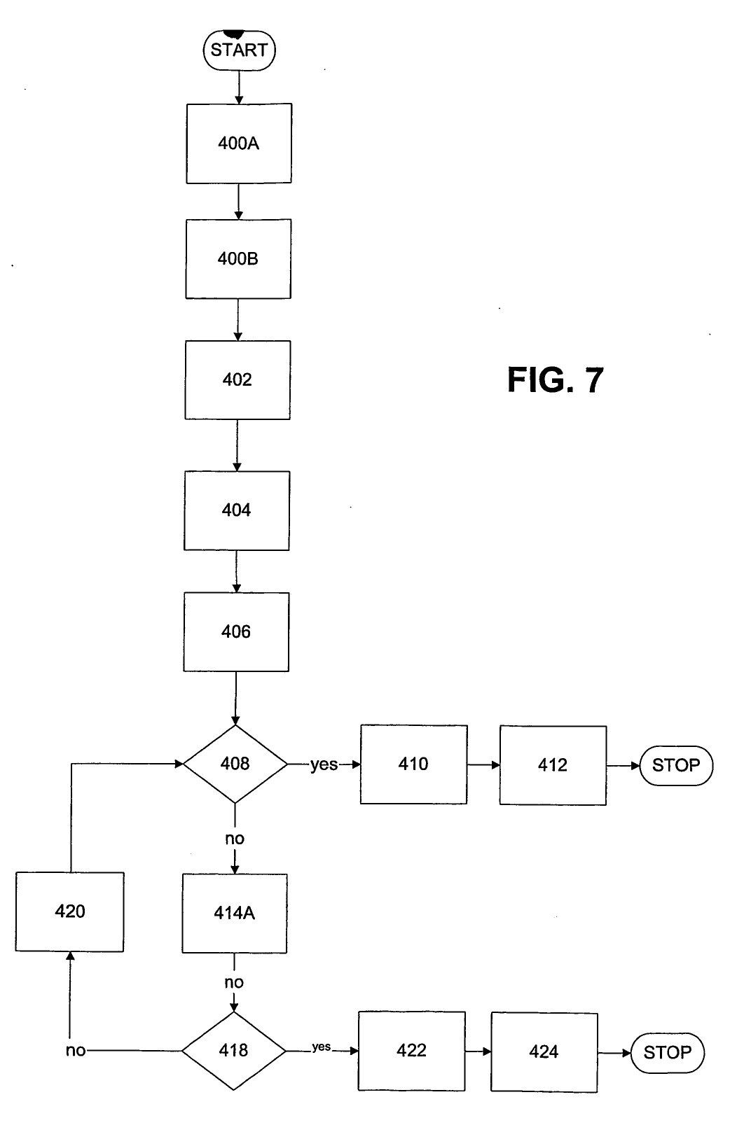

The reception 100 of the request triggers the policy decision device S3 to obtain 105 a policy POL matching to the request and being applicable to an object OBJF. Accordingly, the policy decision device S3 can search one or more policy databases for a policy POL indicating its matching to the respective request information specified in the received request. For example, for a request specifying a certain ACTION as request information, the policy decision device can search in a policy database or an appropriate directory for a policy indicating its matching to the certain ACTION. The policy decision device S3 can stop its search after finding one policy POL matching to the request information or can continue its search and obtain all available policies matching to the request information. A checking of a threshold value can be of advantage in order to limit the number of obtained policies. As more sophisticated algorithms, inter alia for obtaining policies, are described in conjunction with FIG. 6 and 7, the further processes of the flowchart of FIG. 1 are described for a single policy POL matching to the request information obtained according to process step 105, which is not to be understood as limiting.

For the policy POL an associated propagation rule PROP specifying a relation type is obtained as indicated by process 110. The propagation rule PROP may be stated within the policy POL or may be referenced into it. As stated earlier, a policy can comprise more than one propagation rule specifying more than one relation type, which is, for simplicity reasons not further regarded in conjunction with FIG. 1 and is not to be understood as limiting.

According to process 115, the policy decision device S3 applies the propagation rule PROP. The policy decision device S3 verifies if the object OBJR and the object OBJF are linked by a relation path and if the relations of the relation path are in accordance with the relation type specified by the propagation rule PROP. The propagation rule PROP may further specify conditions for the directions of the relations of the propagation path and/or conditions for the objects of the propagation paths, which can be verified in conjunction with process 115. If all verification steps are successfully performed, the policy POL is regarded as being successfully propagated from the object OBJF, to which the policy POL is immediately applicable to, to the object OBJR and the policy decision device S3 proceeds by process 120 and takes a policy decision by applying the successfully propagated policy POL to the object OBJR. For taking the policy decision, the policy decision device S3 can evaluate further policy components like rules or conditions contained in the policy and/or referenced into it. In the decision taking process, the policy decision device S3 can make usage of information comprised in the request and/or may dynamically obtain information e.g. from an external database. Functions, like “GetCurrentTime”, GetCurrentLocation” or “GetTransactionStatus” can be defined usuable for determining the current time, location, transaction status, respectively. One or more functions can be associated to a policy, e.g. included or referenced into it, that are run in the policy decision taking process to obtain freshest information and/or information not available from the request information for taking the policy decision. Thus, including dynamically information into the policy decision taking process can further avoid round trips with the policy enforcement device S2 in case it is determined that request information provided by the policy enforcement device S2 is outdated, invalid, or missing.

The policy decision device S3 can send a response message via interface I32 to inform the policy enforcement device S2 about the policy decision. However, the system may be configured that a lack of a response message comprising the policy decision is always interpreted as a negative policy decision on the object OBJR (or vice versa). The policy enforcement device S2 may wait for a pre-defined time for a response to its request, and if no response message for this request is received until this time, the policy enforcement device S2 may set the corresponding policy decision as negative (or vice versa).

However, the more usual case is that a policy decision is stated in form of a simple ALLOW or DENY statement and sent to the policy enforcement device S2. The policy response can be comprise further information like an identifier relating the response to the earlier request, like the decision time, like the decision authority policy decision device S3, or like one or more OBLIGATIONS, i.e. typically data that specify one or more conditions that are to be verified by the policy enforcement device S2 before allowing an action on the object OBJR. It can be of advantage, if further information is entered into the response dynamically, e.g. based on the usage of functions that are invoked for compiling the response. Especially when using the eXtensible Access Control Markup Language (XACML) as common policy language, it can be useful to use functions to include the further information into one or more obligations thus using obligations as information container for sending the further information from the policy decision device S3 to the policy enforcement device S2, e.g. to indicate information that led to the policy decision. Providing this further information via an obligation as information container can be of advantage as the further information is provided together with the policy decision within one protocol compared to further possible solution wherein the further information is provided via a further protocol level, a further channel, or via a separate message. Using an obligation as information container does not exclude to additionally or parallely use obligations in the original sense in form of conditions to be verified by the policy enforcement device S2 and/or to communicate further information via a further protocol level, a further channel, and/or a separate message.

In FIG. 1, the requestor S1, the policy enforcement device S2, and the policy decision device S3 are depicted as separate entities. However, this set-up has been chosen for illustrative purpose and is not to be understood as limiting. Common platforms can be used comprising two or even three entities of the requestor S1, the policy enforcement device S2, and the policy decision device S3. In case of common platforms, the corresponding interfaces shown in FIG. 1 as external interfaces become internal interfaces. For example, the policy enforcement device S2 and the policy decision device S3 can be hardware devices and/or software modules installed on a common server platform while the requestor S1 resides on a separate computing device. Thus, interfaces I12, I21 are external interfaces and interfaces I23,I32 are internal interfaces for this example.

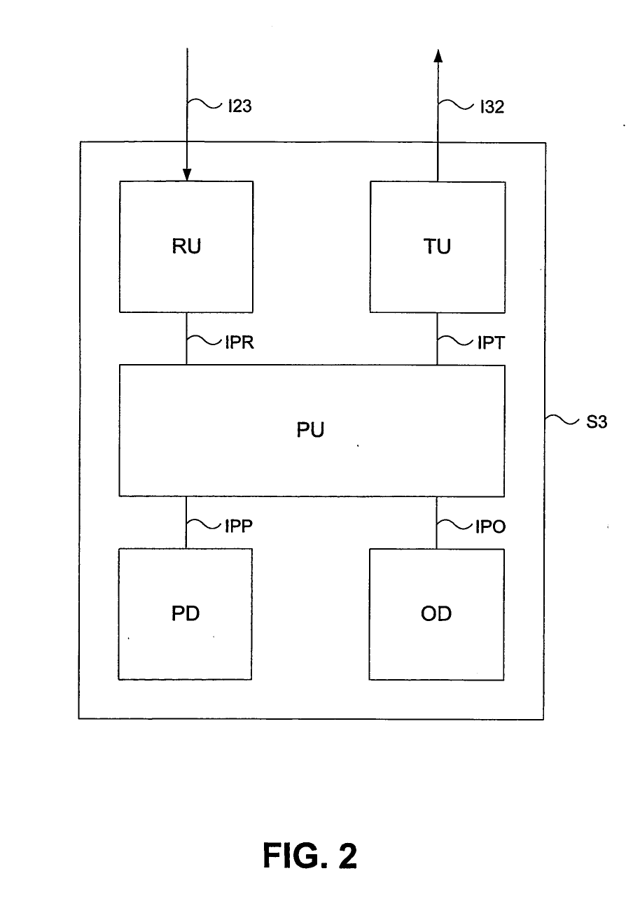

FIG. 2 shows an example for a policy decision device S3 for implementing the invention. The policy decision device S3 comprises a receiving unit RU for receiving the request from the policy enforcement device S2 via internal or external interface I23. The policy decision device S3 further comprises a transmission unit TU for sending the policy decision response to the policy enforcement device S2 via the interface I32. The receiving unit RU and the transmission unit TU can be as depicted separate units of the same or different communication technology. The receiving unit RU and the transmission unit TU can be also integrated in a single unit, e.g. in form of a transceiver. The policy decision device S3 comprises furthermore a processing unit PU connectable to the receiving unit RU via interface IPR for transferring the request received at the receiving unit RU to the processing unit. The processing PU is furthermore connectable to the transmission unit TU via interface IPT for sending the policy decision. The processing unit PU further has access to a policy database PD comprising policies for taking policy decisions on objects according to the invention and further to an object database OD comprising the objects with their relations. Access to the related objects and the policies is performed via interface IPO and interface IPP, respectively. Although depicted as separate databases, databases PD,OD can be also realized by a common database. Furthermore, more than one accessible object database and/or more than one accessible policy database can exist. The one or more object accessible databases and/or the one or more accessible policy databases can be internal to the policy decision device S3 as depicted or externally. Access to the respective one or more databases can be performed permanently or on request via the corresponding interfaces. Interfaces can be permanent or may be established for the respective access. For carrying out the invention the processing unit PU can be adapted to perform process steps of the method as described. The processing unit may be sub-divided into multiple processing components like processors and dynamic memories and individual steps of the method can be executed in a distributed manner by the individual processing components

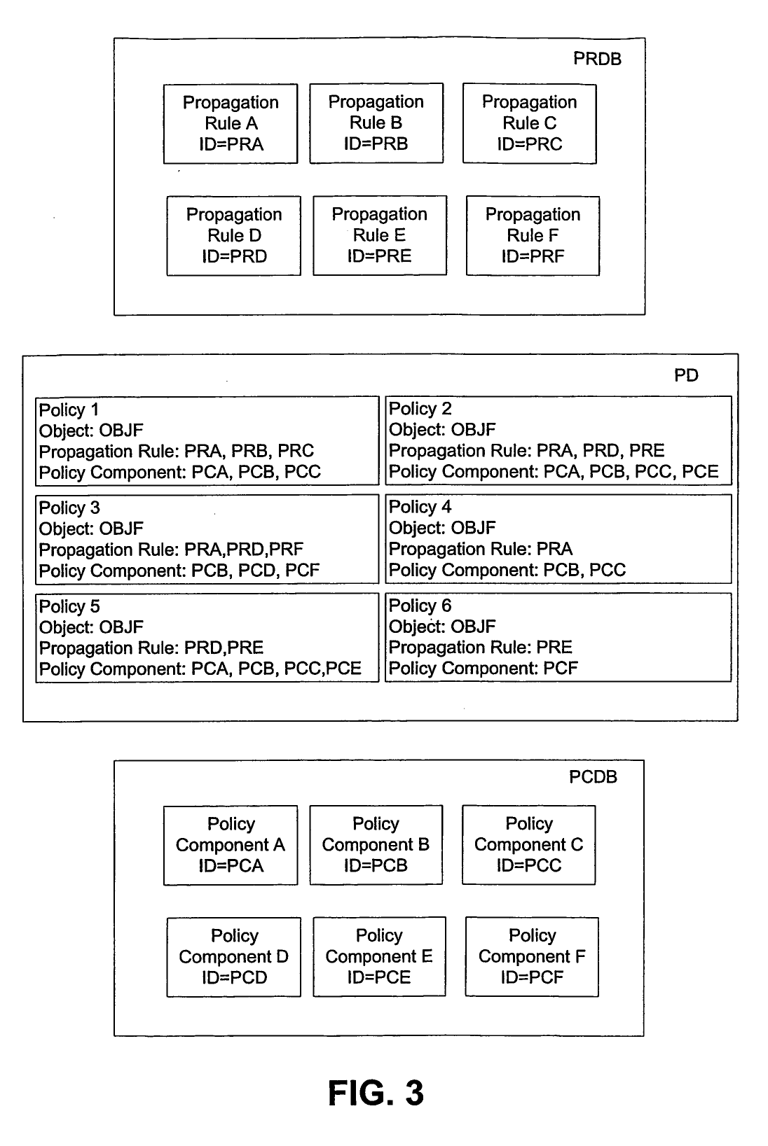

FIG. 3 shows an embodiment of a policy database PD, a propagation rule database PRDB, and a policy component database PCDB. The policy database PD comprises policies 1-6 all immediately applicable to an object OBJF. For indicating its matching to a request, each policy can be associated as explained with appropriate matching information. The associated matching information is not shown in FIG. 3.

The policies further comprise propagation rules and further policy components like further rules or conditions. According to the present example, referencing is used both for the propagation rules PRA-F as well as the further policy components PCA-F stored in the propagation rule database PRDB and the policy component database PCDB, respectively. Therefore, each policy contains one or more appropriate propagation rule reference identifiers and appropriate further policy components reference identifier for referencing to the corresponding propagation rules and further policy components as depicted, e.g. policy 1 being immediately applicable to object OBJF comprises thus propagation rules PRA,PRB,PRC and further policy components PCA,PCB,PCC. As explained earlier, referencing is of advantage if the propagation rules and the policy components are used in multiple policies as e.g. depicted in FIG. 3. However, this does not exclude to explicitly spell out, in addition to or alternatively to referencing, propagation rules and/or further policy components within some or all of the policies. Furthermore, although depicted as separate databases which can be of advantage from an administrative point of view, the policy database PD, the propagation rule database PRDB, and the further component database PCDB can completely or in part be integrated into a common database, e.g. into different propagation rule and further policy component folders or separate files being identifiable by the appropriate reference identifiers.

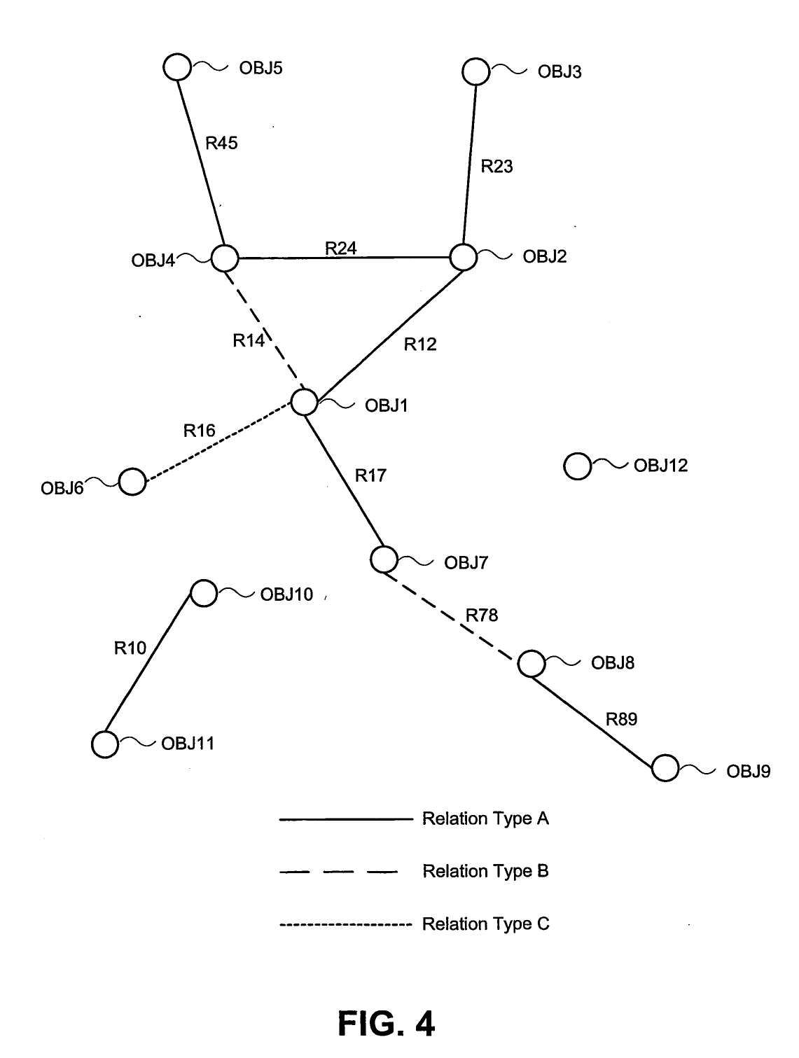

FIG. 4 shows twelve objects OBJ1-12 partly related by relations of three different relations types A-C, which are indicated by different line types in FIG. 4. For explaining the invention, object OBJ1 is used as the object for which a policy decision is requested.

According to a first example, the policy decision device may find a policy matching to the request and being applicable to object OBJ2. The propagation rule associated to the found policy may indicate that relation type A is an allowed type. By applying the propagation rule associated to the found policy, the policy decision device verifies if a relation path between objects OBJ1 and OBJ2 exists and if the existing relation path consists of relations according to the propagation rule. According to the first example, both conditions are fulfilled as a relation path linking objects OBJ1,OBJ2 and consisting of relation R12 exists and the relation R12 is of type A. Thus, the policy decision device can propagate the policy matching to the request and being immediately applicable to the object OBJ2 to the object OBJ1 and can take the policy decision for object OBJ1 based on the propagated policy.

According to second example, the policy matching to the request information is immediately applicable to object OBJ3 and the associated propagation rule allows type A. Compared to the first example, the propagation path between object OBJ3 and object OBJ1 is longer as it additionally comprises object OBJ2 inbetween. The term “longer” is to be understood that a larger number of objects between the first and the second object produces a longer relation path. In a corresponding manner the term “shorter” is defined and used.

The propagation rule can be applied relation-by-relation or for the whole relation path depending on the implementation. In a relation-by-relation implementation, the propagation rule can be applied to the object OBJn to which the policy matching to the request immediately applies to and a next adjacent object OBJn-1. By applying a propagation rule associated to the policy to objects OBJn,OBJn-1 it can be verified that a relation between the objects OBJn,OBJn-1 exists that is of a relation type in accordance with a relation type specified by the propagation rule. If the relation between objects OBJn,OBJn-1 exists and is in accordance with one of the specified relation types, the policy decision device steps to an object OBJn-2 adjacent to object OBJn-1 and applies the same and/or another propagation rule associated to the policy for verifying if an relation between objects OBJn-1,OBJn-2 exists and if this is in accordance with one of the specified relation types. This step-wise verification procedure can be continued relation-by-relation until the object OBJ1 for which a policy decision is requested is reached. Accordingly, the policy matching to the request and the object OBJn is successfully propagated along the relation path consisting of relations between the objects OBJn,OBJn-1,OBJn-2 . . . , OBJ1 with the relations being in accordance with one or more of the allowed relation types. Thus, the propagated policy can be applied to OBJ1 for taking the requested policy decision.

According to the second example, the policy decision device verifies that relation R23 between objects OBJ2,OBJ3 exists and is of the allowed type A and steps further to verify that relation R12 between objects OBJ1,OBJ2 exists and is of the allowed type A. Accordingly, a relation path comprising the relations R12,R23 between the requested object OBJ1 and object OBJ3 exists and is continuously of the allowed type A, therefore allowing the policy matching the request and being immediately applicable to the object OBJ3 to be applied to the object OBJ1 for taking a policy decision for the object OBJ1.

According to a third example, the policy matching to the request is immediately applicable to object OBJ5 and the associated propagation rule allows type A. Accordingly, the policy decision device can successfully verify that relation R45 between objects OBJ4,OBJ5 exists and is of the allowed type A. Arriving at object OBJ4, the policy decision device can first apply the associated propagation rule to the existing relation R14 between objects OBJ4,OBJ1 but would promptly determine that relation R14 is of type B and thus not the allowed type A. The policy decision device may terminate the method as this point but may preferably continue searching for adjacent objects being related to object OBJ4. According to the present example, the policy decision device finds OBJ4 being related by relation R24 to object OBJ2. Accordingly, the policy decision device applies the associated propagation rule to objects OBJ4,OBJ2 and verifies in a positive manner that relation R24 exists and is of the allowed type A. The policy decision device proceeds in a corresponding manner for objects OBJ2,OBJ1 and arrives at the requested object OBJ1 and takes the policy decision. Thus, following multiple relation paths can enhance the success of the propagation of a policy towards the object for which a policy decision is requested.

A fourth example is described being identical to the third example except for the aspect that the associated propagation rule now allows a relation to be of the type A or B. Also in the current example, the policy decision device arrives at object OBJ4 based on the application of the propagation rule to objects OBJ4,OBJ5 and it proceeds by applying the propagation rule to objects OBJ4,OBJ1. Now, the policy decision device verifies that the relation R14 is of type B and thus an allowed type. Correspondingly, the policy decision device does not have to step through the longer path via object OBJ2 but arrives directly at the object OBJL and takes the policy decision for the object OBJ1.

In a fifth example, the policy matching to the request is immediately applicable to object OBJ6 and the associated propagation rule allows type A and/or B. In this case, the application of the propagation rule reveals that the existing relation R16 between is of type C and thus not one of the allowed types. Thus, the policy cannot be propagated from the object OBJ6 to the requested object OBJ1 and no policy decision can be taken based on the obtained policy immediately applicable to the object OBJ6. In a corresponding manner, no policy decision for object OBJ1 can be taken if polices matching to the request are found that are immediately applicable to objects OBJ10, OBJ11,OBJ12, because of the lack of a relation path to object OBJ1.

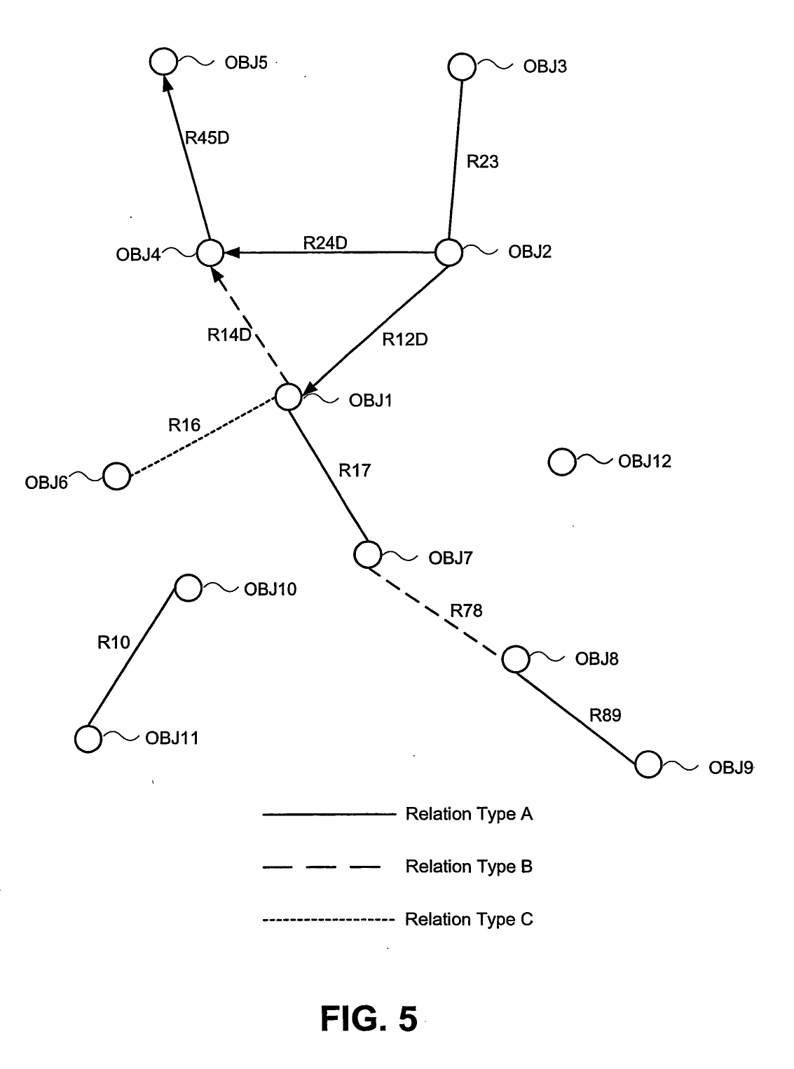

FIG. 5 differs from FIG. 4 by the fact that the relations R12,R14,R24,R45 between objects OBJ1,OBJ2,OBJ4,OBJ5 are now directed relations R12D,R14D,R24D,R45D. As before, object OBJ1 is the object for which a policy decision is requested. A policy matching to the request being immediately applicable to object OBJ5 is obtained. According to a first example for FIG. 5, the propagation rule associated to the obtained policy specifies an allowed relation type of type A and a direction of relations of the relation path from the object in question to the object to which the policy is immediately applicable to, i.e. from object OBJ1 to object OBJ5, respectively, according to the present example. According to the relation-by-relation propagation procedure, the policy decision device verifies successfully that the relation R45D between the objects OBJ4,OBJ5 exists, that the relation R45D is of the allowed type A and of the allowed direction. Subsequently, the policy decision device successfully verifies the existence of relation R24D being of the allowed type A and of the allowed direction. However, when verifying the relation R12D between the objects OBJ1,OBJ2, the policy decision device determines that the relation R12D is directed towards the object OBJL and thus does not conform to the direction specified by the propagation rule. Accordingly, the policy decision device discards the propagation path consisting of R45,R24,R12 as invalid propagation path and does not take a policy decision.

According to a second example for FIG. 5, the associated propagation rule specifies in addition to the first example for FIG. 5 that also type B is an allowed type. Accordingly, the policy decision device has more options as in the first example for FIG. 5 as a relation path consisting of relations R45D,R14D exists that satisfies the requirements by the propagation rule, i.e. relation R45D is of allowed type A and relation R14 is of allowed type B and both relations R45D,R14D of the relation path are directed from object OBJ1 to object OBJ5. Thus, the policy can be successfully propagated from object OBJ5 to object OBJ1 for taking a policy decision on OBJ1.

Relation types, relation directions, and/or object conditions can be specified by a propagation rule in a sense of allowed relation types, allowed relation directions, and/or allowed object conditions. Thus, relations and objects of the relation path have to be verified to be in accordance with the respective allowed relation types, allowed relation directions, and/or allowed object conditions. Alternatively, relation types, relation directions, and/or object conditions can be specified by a propagation rule in an opposite manner, e.g. by an exclusion list. Thus, a blank propagation rule without any specifications of relation types, relation directions, and/or object conditions would allow the propagation along a relation path of any type, of any direction, and any objects. For those relation types, relation directions, and/or object conditions that are stated on the exclusion list, a propagation is not allowed, i.e. when verifying if a relation path is in accordance with the specifications of the propagation rule it is checked whether the relation path contains any relations or objects that are in accordance with the exclusion list. If there is at least one relation type, relation direction, or object condition of the relation path that conforms to a respective excluded item, the propagation is not allowed.

The effective decoupling of the set of objects and the policies according to the invention has further advantages, e.g. the set of objects can be very complex with many objects and many relations of multiple relation types while still keeping the policies very simple as—explained before for the objects—at minimum only one object has to be identifiable to which a policy is immediately applicable to as starting object for the further steps. As indicated by FIG. 4 and 5, even cyclic relation arrangements, i.e. relations R12,R14,R24 and R12D,R14D,R24D, are possible which is an advantage over classical policy systems that do not allow for cyclic relation arrangements of objects.

Referring now to FIG. 6 for explaining a method according to an embodiment of the invention to be implemented in a policy decision device for taking a policy decision. The method can be triggered by the reception of a request for a policy decision for an object OBJR and can proceed after its start by process 400 in which the policy decision device determines a set of existing relation paths PT starting at object OBJR. For the creation of the set, a path finding procedure based on breadth-first-search (BFS) algorithms can be executed. Next, according to process step 402, the size of set of the relation paths PT is determined, e.g. by counting the number of found relation paths resulting in a number L.

In an optional but preferred optimization step, the individual found relation paths of set PT are ordered by increasing length. The policy decision device may use an index i for the ordering of the relation paths PT1, PT2, PT3, . . . PTL with a condition that relation path PTi<= relation path PT(i+1) with i=1 . . . , L-1. The ordering is of advantage as in further process steps involving the propagation of a policy through a relation path by applying one or more associated propagation rules, the policy decision device can start it's verification process with shorter relation paths which is of advantage as less verification steps are necessary and thus the probability for a successful propagation increases with decreasing relation path length.

In process step 406, variable i is set to 1, i.e. i=1. According to process step 408, it is checked if the current value for i is larger than L, i.e. i>L. If this condition is fulfilled, than all relation paths of the set of relation paths PT are checked and no policy for taking a policy decision for the object in question is found. Consequently, the policy decision device determines according to process steps 410 that there is no matching policy that can be used for taking a policy decision on object OBJR. The policy decision device can proceed by process step 412 for generating an appropriate decision response and communicating it to the requesting policy enforcement device and can stop as indicated. However, if in process step 408, variable i is found to be equal or lower than L, i.e. i<=L, than the method steps to process step 414 wherein the policy decision device obtains a set of policies Pi applicable to the last object of the current relation path PTi,m and matching to request information of the policy decision request. The notation Pi is chosen in order to indicate that the set of policies relate to the current relation path PTi, i.e. the policies of the set Pi are all immediately applicable to the last object of the current relation path PTi. The parameter m is a path length indicator, hence, PTi,m denotes the current path of length m. The last object in a relation path PTi,m of length m is defined as the m+1th object in the relation path starting at the object OBJR, i.e. a relation path PTi,m=1 of length one comprises one relation between two objects OBJR and OBJ1 with OBJ1 being the last object. Accordingly, the last object for a relation path PTi,m=2 is OBJ2 with the relation path comprising further the object OBJR and inbetween a further object OBJL and so on for longer relation paths indicatable by higher numbers of m.

In process step 416 it is checked if the set of policies Pi is empty. If yes, there is no matching policy in set Pi and the method proceeds to process step 420 wherein i is increased by 1, i.e. i=i+1 and the method turns to process steps 408 and continues as described before for next relation path PTi according to the current value of i.

However, if in process step 416, the set Pi is not empty, the method proceeds to process step 418 wherein it is verified if for current relation path PTi a propagation of at least one of the policies of set Pi from the last object of PTi to the object OBJR is possible, i.e. it is verified if the current relation path complies with the requirements of the one or more propagation rules associated to a policy of set Pi. If the requirements regarding the relation type of the relations of the relation path PTi and optionally regarding the direction of the relations of the relation path PTi and/or optionally regarding objects of the relation path PTi are fulfilled for a policy of set Pi, e.g. relation-by-relation and object-by-object, then this policy can be successfully propagated to object OBJR and the policy decision device proceeds to process step 422 and applies this policy to object OBJR for taking the policy decision for object OBJR. A policy decision response can be generated at process step 424 and communicated to the policy enforcement device that originally requested the decision.

If, however, no one of the policies of current set Pi can be successfully propagated in process step 418, the method proceeds from process step 418 to process step 420 (i=i+1), further to process step 408 (i>L?), and continues as explained before depending on the current value of i, the current relation path PTi and the policies of the current policy set Pi with their respective associated propagation rules.

Referring now to FIG. 7 showing an alternative flowchart of process to FIG. 6. References that are identical in both figures mean same process steps. The method according to FIG. 7 starts by a request for a policy decision to be taken for object OBJR. According to process step 400A, the policy decision device determines a set of objects On such that for each of the objects at least one policy exists that matches to the request and that is immediately applicable to the respective object of set On. The method proceeds by process step 400B wherein a set of all relation paths PT is determined for which each relation paths links object OBJR and one of the objects of set On. Accordingly, the policy decision device now has access to a set of related objects. The related objects are related by relation paths of set PT. Each relation path of the set PT comprises at the one end object OBJR and at the other end as last object one of the objects of the set On.

The method continues by process step 402 for determining the number L of the relation paths of set PT, further with process step 404 wherein the relation paths of set PT are sorted in increasing length which is of advantage as explained earlier, and carries out process step 406 (i=1) and process step 408 (i>L?) and possibly steps 410 and 412 if i>L.

If i<=L, than the policy decision device determines according to process step 414A the set Pi of policies that are applicable to the last element for the current relation path PTi. Due to the preceding step 400A, it is guaranteed that each policy of set Pi matches to the request and no further verification of the matching of the policy and the request information needs to be performed in step 414A. The method proceeds to process step 418 and continues as described in conjunction with FIG. 6.

The invention as described in this application is especially advantageous for policy systems taking policy decisions for larger numbers of related objects, comprising many policies, and that are very dynamic, e.g. the objects, the relations between objects, and the policies can be subject to frequent changes. Examples for such large, dynamic systems are firewalls, subscriber management in a communication system, or management of resources of a company.

1. A method for taking a policy decision by a policy decision device, wherein the policy decision device has access to objects being relatable to each other by relations of one or more relation types, the method comprising the steps of
receiving a request for the policy decision, the request specifying a first object of the objects and request information,
obtaining a policy matching to the request information and being applicable to a second object of the objects,
obtaining at least one propagation rule associated to the policy, the at least one propagation rule specifying at least one relation type of the one or more relation types,
verifying if a relation path exits, the relation path linking the first object and the second object and consisting of one or more of the relations,
verifying if the one or more relations of the relation path are in accordance with at least one of the at least one specified relation type, and
if said relation path exists and if said one or more relations of the relation path are in accordance, applying the policy to the first object for taking the policy decision.

2. The method according to claim 1, wherein the at least one propagation rule specifies at least one direction and the method further comprises the step of verifying if the one or more relations of the relation path are in accordance with the at least one specified direction.

3. The method according to claim 1, wherein the at least one propagation rule specifies at least one condition that is verified for at least one of the objects of the relation path.

4. The method according to claim 1, wherein the existence of the relation path is considered for obtaining of the policy.

5. The method according to claim 1, wherein the at least one propagation rule is obtained from at least one propagation rule database on the basis of at least one reference identifier associated to the at least one propagation rule and the policy.

6. The method according to claim 1, wherein at least one further policy component of the policy is obtained from at least one policy component database based on at least one reference identifier associated to the at least one further policy component and the policy.

7. A policy decision device for taking a policy decision, the policy decision device comprising:
a receiving unit and
a processing unit, wherein the processing unit is adapted to access objects being relatable to each other by relations of one or more relation types, the receiving unit is adapted to receive a request for the policy decision, the request specifying a first object of the objects and request information, the processing unit is further adapted to obtain a policy matching to the request information and being applicable to a second object of the objects, to obtain at least one propagation rule associated to the policy, the at least one propagation rule specifying at least one relation type of the one or more relation types, to verify if a relation path exits, the relation path linking the first object and the second object and consisting of one or more of the relations, to verify if the one or more relations of the relation path are in accordance with at least one of the at least one specified relation type, and if said relation path exists and if said one or more relations of the relation path are in accordance, to apply the policy to the first object for taking the policy decision.

8. The policy decision device according to claim 7, wherein the at least one propagation rule specifies at least one direction and the processing unit is adapted to verify if the one or more relations of the relation path are in accordance with the at least one specified direction.

9. The policy decision device according to claim 7, wherein the at least one propagation rule specifies at least one condition and the processing unit is adapted to verify, for at least one of the objects of the relation path, if said at least one object is in accordance with the at least one condition.

10. The policy decision device according to claim 7, wherein the processing unit is adapted to consider the existence of the relation path for the obtaining of the policy.

11. The policy decision device according to claim 7, wherein the processing unit is adapted to obtain the at least one propagation rule from at least one propagation rule database on the basis of at least one reference identifier associated to the at least one propagation rule and the policy.

12. The policy decision device according to claim 7, wherein the processing unit is adapted to obtain at least one further policy component of the policy from the at least one policy component database based on at least one reference identifier associated to the at least one further policy component and the policy.

13. A computer program loadable into a policy decision device, the computer program comprising code adapted
to access objects being relatable to each other by relations of one or more relation types, to process a request for a policy decision, the request specifying a first object of the objects and request information,
to obtain a policy matching to the request information and being applicable to a second object of the objects,
to obtain at least one propagation rule associated to the policy, the at least one propagation rule specifying at least one relation type of the one or more relation types,
to verify if a relation path exits, the relation path linking the first object and the second object and consisting of one or more of the relations,
to verify if the one or more relations of the relation path are in accordance with at least one of the at least one specified relation type, and
if said relation path exists and if said one or more relations of the relation path are in accordance, to apply the policy to the first object for taking the policy decision.

14. The computer program according to claim 13, wherein the at least one propagation rule specifies at least one direction and the computer program comprises code adapted to verify if the one or more relations of the relation path are in accordance with the at least one specified direction.

15. The computer program according to claim 13, wherein the at least one propagation rule specifies at least one condition and the computer program comprises code adapted to verify for at least one of the objects of the relation path if said at least one object is in accordance with the at least one condition.

16. The computer program according to claim 13, wherein the computer program comprises code adapted to consider the existence of the relation path for obtaining of the policy.

17. The computer program according to claim 13, wherein the computer program comprises code adapted to obtain the at least one propagation rule from at least one propagation rule database on the base of at least one reference identifier associated to the at least one propagation rule and the policy.

18. The computer program according to claim 13, wherein the computer program comprises code adapted to obtain at least one further policy component of the policy from the at least one policy component database based on at least one reference identifier associated to the at least one further policy component and the policy.
